(19) United States
(12) Patent Application Publication
(10) Pub. No.: US 2023/0043488 A1
(43) Pub. Date: Feb. 9, 2023

(54) WALKING CANE HAVING INTEGRAL GRIPPING MECHANISM

(71) Applicant: Edward L. Rollins, Las Vegas, NV (US)

(72) Inventor: Edward L. Rollins, Las Vegas, NV (US)

(21) Appl. No.: 17/973,862

(22) Filed: Oct. 26, 2022

Related U.S. Application Data
(63) Continuation-in-part of application No. 17/169,429, filed on Feb. 6, 2021, now Pat. No. 11,484,102.
(60) Provisional application No. 63/103,340, filed on Aug. 3, 2020.

(51) Int. Cl. A45B 3/00; A45B 9/02; A45B 9/04; A45B 3/04; B25J 1/04

(52) U.S. Cl. CPC A45B 3/00; A45B 9/02; A45B 9/04; A45B 3/04; B25J 1/04

(57) ABSTRACT

A walking cane having an integral gripping mechanism; the walking cane having the integral gripping mechanism includes a T-shaped walking cane having an illumination member and a gripping mechanism actuated by a trigger. The gripping mechanism includes a stationary gripping lever and a mobile gripping lever hosted on an axle which is configured to move in relation to the stationary gripping lever. The walking cane having integral gripping mechanism provides users with additional independence and mobility.

### CROSS-REFERENCE TO RELATED APPLICATIONS

This application is a continuation-in-part of U.S. patent application Ser. No. 17/169,429, filed on Feb. 6, 2021, which issued as U.S. Pat. No. 11,484,102 on Nov. 1, 2022, which in turn claims the benefit of U.S. Provisional Patent Application No. 63/103,340, filed on Aug. 3, 2020. The entire disclosure of the above application is incorporated herein by reference.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of mobility assistance devices of existing art and more specifically relates to walking canes

### RELATED ART

Canes, crutches, and other walking aids may be used. Reaching or grasping tools (commonly called “reachers”) may also be known, and typically consist of an elongate member with a remotely actuable jaw to capture or lift various articles. Combination cane and reaching tools have been developed, and may be used by a person who has temporarily or permanently limited movement of the feet, ankles, legs, knees, hips or back. Such a person may be able to walk with a cane but has difficulty in bending down to pick up or move anything from the floor, ground or knee level. However, known cane-reacher combinations are heavy, complicated mechanisms, and are difficult for the user to manipulate. A suitable solution is desired.

U.S. Pat. No. 5,176,160 to Osborn relates to a combination cane and reaching apparatus. The described combination cane and reaching apparatus includes a combination cane and reaching apparatus which includes a cane body having a longitudinal axis and terminating in a pair of ends, a top end having a handle member including a grip portion extending in a direction generally perpendicular to the cane body longitudinal axis, and a bottom end terminating in a cane tip. A trigger portion is secured to the cane body proximate the handle member, and includes a trigger element and a trigger pivot axis. A jaw portion is secured to the cane body proximate the cane tip, and includes a jaw element, a jaw pivot axis, and a spring. A string capture or lock portion is attached to the cane body between the trigger portion and jaw portion. A cable or string segment connects the trigger element and jaw element, with the string segment bearing a bead or knot along its length proximate the string lock portion.

### SUMMARY OF THE INVENTION

In view of the foregoing disadvantages inherent in the known walking cane art, the present disclosure provides a novel walking cane having integral gripping mechanism. The general purpose of the present disclosure, which will be described subsequently in greater detail, is to provide an efficient and effective walking cane having an integral gripping mechanism.

A walking cane having integral gripping mechanism is disclosed herein. The walking cane having integral gripping mechanism includes a T-shaped walking cane having an elongated hollow cylindrical body, a base, and a handle being positioned opposite of the base. The handle includes a first-section and a second-section, an illumination member positioned at the first-section, a light-activation button, and a trigger hosted on a trigger-axle being positioned proximal to the second-section. The T-shaped walking cane further includes a gripping mechanism actuated by the trigger. The gripping mechanism is comprised of a stationary gripping lever and a mobile gripping lever hosted on an axle configured to move in relation to the stationary gripping lever. The walking cane having integral gripping mechanism provides users with additional independence and mobility.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

In one embodiment, a T-shaped walking cane has an elongated hollow cylindrical body, a base, a handle, and a gripping mechanism. The handle is positioned opposite of the base. The handle has a first-section, a second-section, an illumination member positioned at the first-section, a light-activation button, and a trigger hosted on a trigger-axle being positioned proximal to the second-section. The gripping mechanism is actuated by the trigger and includes a stationary gripping lever and a mobile gripping lever. The stationary gripping lever is affixed to the elongated hollow cylindrical body adjacent to the base of the T-shaped walking cane. The stationary gripping lever has a first arcuate inner surface with a first textured grip including a first rubber coating in which a plurality of first pliable ridges are formed. The stationary gripping lever terminates in a first flat end section disposed adjacent to the first arcuate inner surface. The first pliable ridges are formed along an entirety of the first arcuate inner surface. A first hard stop surface is disposed between the first arcuate inner surface and the elongated hollow cylindrical body. The mobile gripping lever has a hinge area hosted on an axle and disposed adjacent to the stationary gripping lever. The mobile gripping lever is configured to move in relation to the stationary gripping lever via a manual operation of the trigger. The mobile gripping lever has a second arcuate inner surface with a second textured grip including a second rubber coating in which a plurality of pliable ridges are formed. The mobile gripping lever terminates in a second flat end section disposed adjacent to the second arcuate inner surface. The second pliable ridges are formed along an entirety of the second arcuate inner surface. Each of the first arcuate inner surface and the second arcuate inner surface are concave, and the first arcuate inner surface faces the second arcuate inner surface. A second hard stop surface is disposed between the second arcuate inner surface and the hinge area of the mobile gripping lever. The second hard stop surface is configured to abut the first hard stop surface when the trigger is fully retracted to move the mobile gripping lever into a closed-condition.

### BRIEF DESCRIPTION OF THE DRAWINGS

The figures which accompany the written portion of this specification illustrate embodiments and methods of use for the present disclosure, a walking cane having an integral gripping mechanism, constructed and operative according to the teachings of the present disclosure.

FIG. 1 is a perspective view of the walking cane having integral gripping mechanism during an ‘in-use’ condition, according to an embodiment of the disclosure.

FIG. 2 is a perspective view of the walking cane having integral gripping mechanism of FIG. 1 in an open-condition, according to an embodiment of the present disclosure.

FIG. 3 is a perspective view of the walking cane having integral gripping mechanism of FIG. 1 in an closed-condition, according to an embodiment of the present disclosure.

FIG. 4 is a perspective view of a gripping mechanism of the walking cane having integral gripping mechanism of FIG. 1, according to an embodiment of the present disclosure.

FIG. 5 is a perspective view of an illumination member of the walking cane having integral gripping mechanism of FIG. 1, according to an embodiment of the present disclosure.

The various embodiments of the present invention will hereinafter be described in conjunction with the appended drawings, wherein like designations denote like elements.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As discussed above, embodiments of the present disclosure relate to a walking cane and more particularly to a walking cane having integral gripping mechanism as used to improve the effective use of walking canes.

Generally, the disclosed walking cane having the integral gripping mechanism includes a T-shaped walking cane having a centered and two-sided handle that can be evenly gripped by both hands when using the T-shaped walking cane to stand or sit, thus effectively ensuring even distribution of weight and force on the T-shaped walking cane, and thus also preventing the common slippage that ordinarily occurs with standard walking canes during such cane-assisted standing and sitting procedures.

The T-shaped walking cane features a user-controlled gipping mechanism that can be easily utilized to grasp items without the need for the user to bend, stretch, or extendedly reach for items. The gripping mechanism is trigger actuated by a trigger positioned proximal to the handle. The gripping mechanism comprises a stationary gripping lever and a mobile gripping lever. The stationary gripping lever ends in a flush position to the bottom of the T-shaped walking cane and the mobile gripping lever ends in that same position when the gripping mechanism is in a closed-condition. The levers of the gripping mechanism preferably feature a rubber coating. The rubber coating features pliable ridges which enhance gripping capabilities of the gripping mechanism and ensure it can grasp small and slick items, such as medicine bottles.

An illumination member is further included in preferred embodiments within the handle of the T-shaped walking cane to provide the user with illuminated visibility of the immediate area. Extending from the trigger, and within the interior of the hollow vertical base of the structure, is a cable of an approximate twenty-nine inch (29″) length. The opposite endpoint of the cable attaches to the mobile gripping lever featured at the bottom end of the vertical base of the walking cane having integral gripping mechanism. The cable may be included within a vertical portion of the walking cane having integral gripping mechanism or may be featured outside and attached upon the vertical portion.

In one embodiment, the walking cane having the integral gripping mechanism is made of aluminum alloy with a hollow cylindrical profile, measuring about thirty-four inches in length by about one inch in diameter (34″×1″). The handle of the walking cane having integral gripping mechanism is made of aluminum alloy in a hollow cylindrical format, measuring nine inches in length by one inch in diameter (9″×1″). One side of the handle, upon its bottom area, features an indentation of size to accommodate the trigger when fully retracted. Applied to an endpoint of this horizontal handle is a sealing cap, made of synthetic rubber. Applied to the opposite endpoint of this handle is an illumination member of light-emitting diode (LED) format, which broadcasts at approximately eight hundred lumens (800 lm) in brightness. The LED is powered by battery, contained behind the LED lighting piece, and is accessible by removal of the endcap that hosts the LED. Both a vertical base and horizontal handle of the walking cane having integral gripping mechanism can be made in various lengths and diameters. The walking cane having integral gripping mechanism can be made in versions in which its height is adjustable, and by various means such as spring-loaded tabs and spaced apertures for example. Other suitable means may be used.

A method of use is as follows: A user may grip the walking cane having integral gripping mechanism as they would an ordinary walking cane while using it during mobility. When attempting to sit, the user may hold both ends of the handle to lower him- or herself to a seat, and may then grip both ends of the handle to raise him- or herself when standing from the seat. Gripping both ends of the handle, and which are centered on the base, allows the user to evenly distribute the weight and force of these tasks, thus substantially eliminating risks of falls caused by uneven distribution of weight and force upon an ordinary walking cane during these tasks. Should the user need to retrieve an item, the user can access that object with use of the handle, which eliminates the need for bending, stretching and/or kneeling to complete this procedure, which eliminates the risk of falling during said procedure. The illumination member of the walking cane having integral gripping mechanism can be activated at any time to improve visibility of the area in which the user is moving.

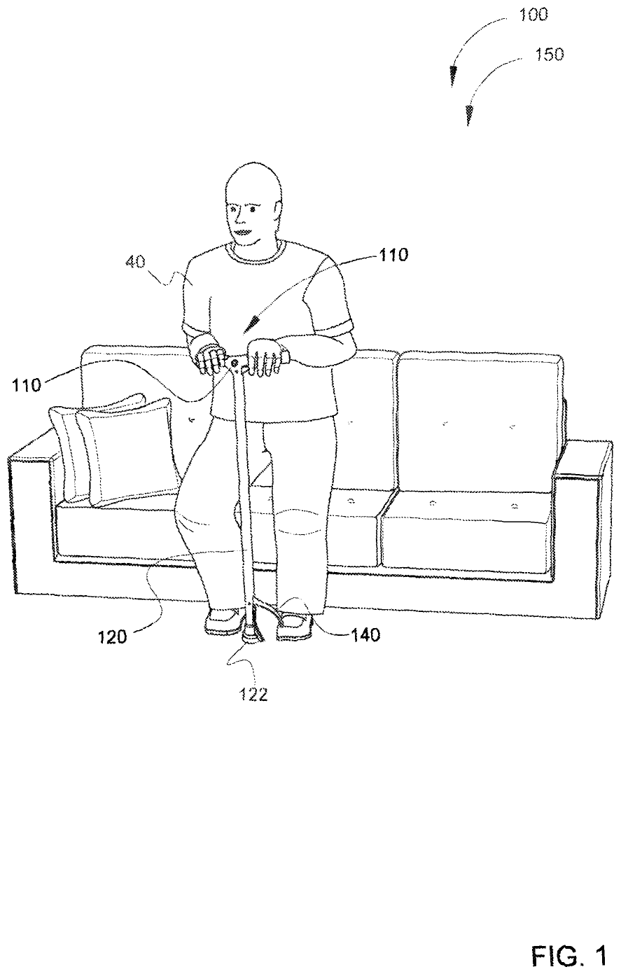

Referring now more specifically to the drawings by numerals of reference, there is shown in FIGS. 1-5, various views of a walking cane having integral gripping mechanism 100.

FIG. 1 shows a walking cane having integral gripping mechanism 100 during an ‘in-use’ condition 150, according to an embodiment of the present disclosure. As illustrated, the walking cane having integral gripping mechanism 100 may include a T-shaped walking cane 110 having an elongated hollow cylindrical body 120, a base 122, and a handle 128 being positioned opposite of the base 122. The handle 128 includes a first-section 130 and a second-section 132, an illumination member 134 positioned at the first-section 130, a light-activation button 136, and a trigger 138 hosted on a trigger-axle 139 being positioned proximal to the second-section 132. The trigger 138 is positioned directly below the handle 128. The T-shaped walking cane 110 further includes a gripping mechanism 140 actuated by the trigger 138. The gripping mechanism 140 is comprised of a stationary gripping lever 142 and a mobile gripping lever 144 hosted on an axle 147 configured to move in relation to the stationary gripping lever 142. The gripping mechanism 140 allows for items to be retrieved without requiring a user 40 to overly extend, bend or stoop.

In one embodiment, the elongated hollow cylindrical body 120 of the T-shaped walking cane 110, can be of adjustable length, for example, telescopic.

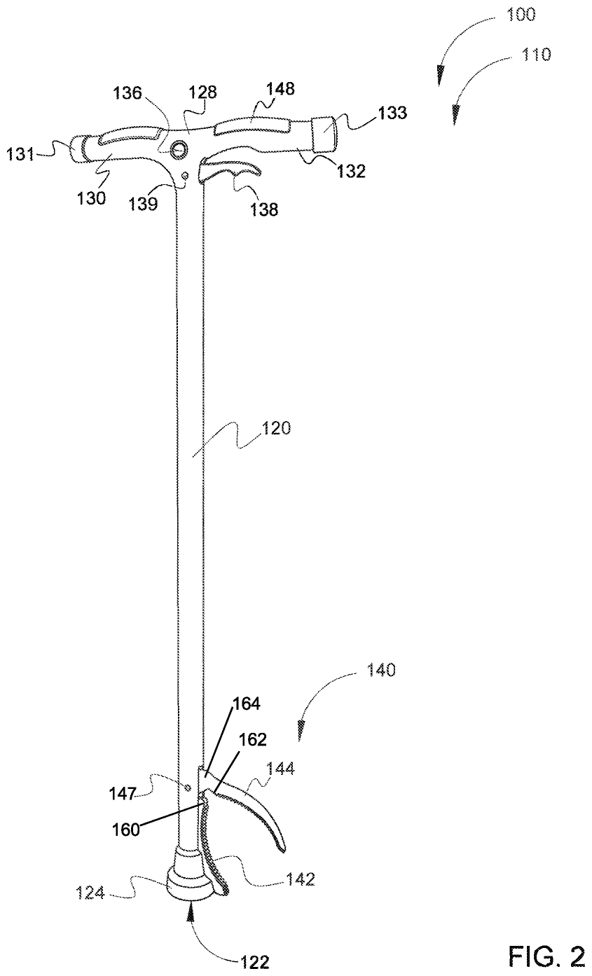

FIG. 2 shows the walking cane having integral gripping mechanism 100 of FIG. 1, according to an embodiment of the present disclosure. As above, the walking cane having integral gripping mechanism 100 comprises the T-shaped walking cane 110 having the gripping mechanism 140. As shown, the T-shaped walking cane 110 is defined by the elongated hollow cylindrical body 120, the base 122, and the handle 128. The handle 128 is horizontally-centered upon a vertical shaft of the elongated hollow cylindrical body 120 forming the T-shaped walking cane 110. The handle 128 of the T-shaped walking cane 110 may be gripped upon both ends while sitting or standing. The base 122 preferably comprises a textured base-cap 124. The textured base-cap 124 may comprise a synthetic rubber material and an exterior contact plane of the textured base-cap 124 is textured for additional gripping action.

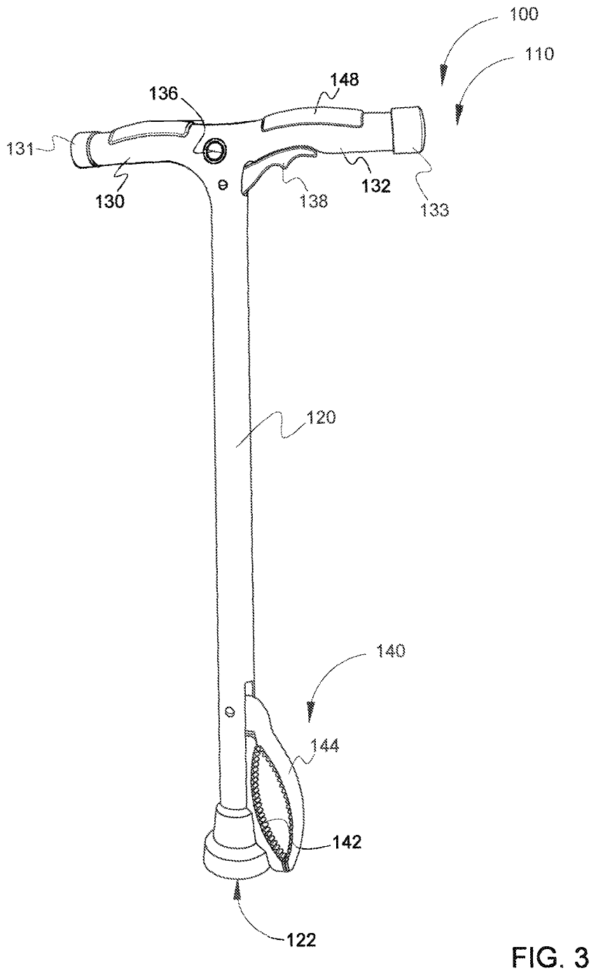

FIG. 3 is a perspective view of the walking cane having integral gripping mechanism 100 of FIG. 1, according to an embodiment of the present disclosure. The stationary gripping lever 142 ends in a flush position to the base 122 of the T-shaped walking cane 110. The second-section 132 of the handle 128 comprises a trigger-indentation to accommodate the trigger 138 when fully retracted. Depression of the trigger 138 initiates retracting of the mobile gripping lever 144 into a closed-condition and releasing of the trigger 138 initiates extending of the mobile gripping lever 144. The handle 128 comprises an upward arch profile providing an ergonomic grip area. Additionally, the first-section 130 and the second-section 132 of the handle 128 each further comprise a padded portion 148. The walking cane having integral gripping mechanism 100 may be made of various materials, including various woods, metals, and plastics of applicable durability. The walking cane having integral gripping mechanism 100 allows users to perform additional tasks independently and without assistance from others.

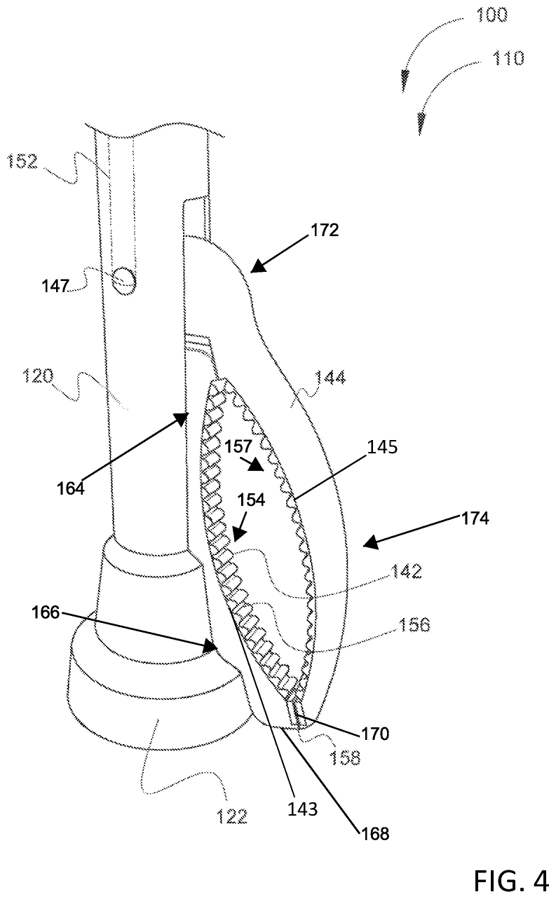

FIG. 4 is a perspective view of the walking cane having integral gripping mechanism 100 of FIG. 1, according to an embodiment of the present disclosure. As illustrated in FIG. 4 the gripping mechanism 140 comprises the stationary gripping lever 142 which has a first arcuate inner surface 143 and the mobile gripping lever 144. Which has a second arcuate inner surface 145. Each of the first arcuate inner surface 143 and the second arcuate inner surface 145 are concave. The first arcuate inner surface 143 faces the second arcuate inner surface 145. The elongated hollow cylindrical body 120 houses a cable 154 extending from the trigger 138 to the mobile gripping lever 144 which is configured to initiate movement of the mobile gripping lever 144. The first arcuate inner surface 143 of the stationary gripping lever 142 and the second arcuate inner surface 145 of the mobile gripping lever 144 comprise mating textured grips. The first arcuate inner surface 143 and the second arcuate inner surface 145 may respectively include a first rubber coating and a second rubber coating which form the mating textured grips. As shown, the mating textured grips may include pliable ridges 156. Each of the arcuate inner surfaces 143, 145 may terminate in flat end sections 158. The stationary gripping lever 142 and the mobile gripping lever 144 form a gripping claw configured to assist a user with picking up at least one item. The flat end sections 158 allow the gripping mechanism 140 to pick up small items, like a pen, on flat surfaces, such as the floor.

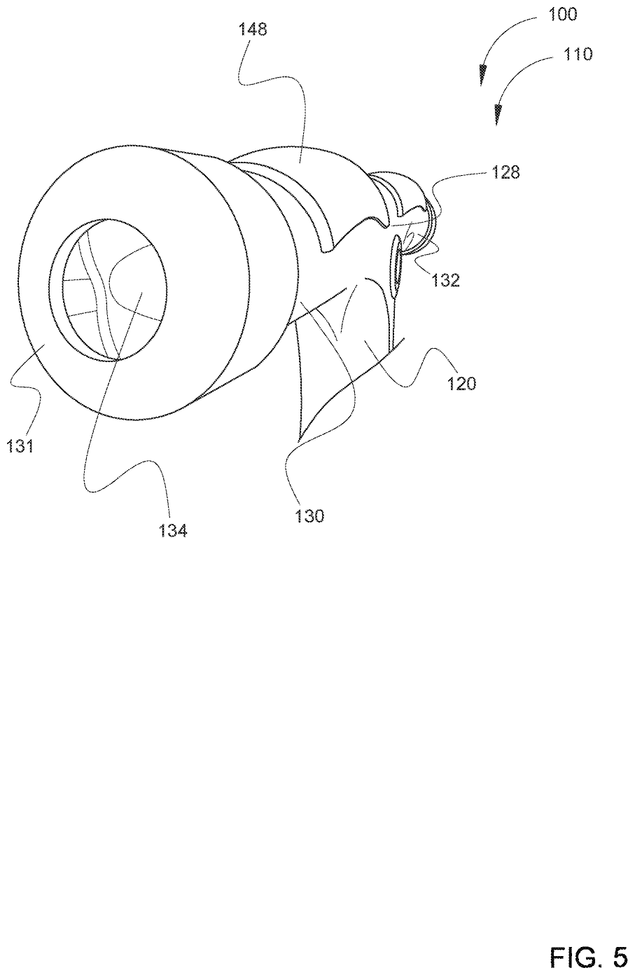

FIG. 5 is a perspective view of the handle 128 of the walking cane having integral gripping mechanism 100 of FIG. 1, according to an embodiment of the present disclosure. As shown, the handle 128 includes the illumination member 134 positioned at the first-section 130 and the light-activation button 136 for activating and alternatively deactivating the illumination member 134. The illumination member 134 of the walking cane having integral gripping mechanism 100 may be of various varieties, such as but not limited to an LED light and bulb. The T-shaped walking cane 110 further includes a first-endcap 131 and a second-endcap 133. The first-endcap 131 may be removable and is positioned at the first-section 130 and being configured to host the LED light. The illumination member 134 may be powered by various battery sizes and types, including rechargeable batteries, and the batteries may be featured in various locations of the T-shaped walking cane 110. Additionally, the illumination member 134 may be activated by various means, such as but not limited to the light-activation button 136 or a switch, and may be featured in various locations on the handle 128.

In a particular embodiment, the walking cane 110 having the integral gripping mechanism 100 has the gripping mechanism 140 with both the stationary gripping lever 142, and the mobile gripping lever 144. The stationary gripping lever 142 is shaped with the first arcuate inner surface 143, and the mobile gripping lever 144 is similarly shaped, having the second arcuate inner surface 145. The shaping of the first arcuate inner surface 143 and the second arcuate inner surface 145 facilitates the ability to exercise a more delicate, controlled grip on items.

Advantageously, as shown in FIG. 4, in this embodiment each the first arcuate inner surface 143 of the stationary gripping lever 144, and the second arcuate inner surface 145 of the mobile gripping lever, have a first textured grip 154, and a second textured grip 157 that each extend the entire length of each the first arcuate inner surface 143 and the second arcuate inner surface 145. The first textured grip 154 and the second textured grip 157 together make it possible for the user to have more control gripping items of various sizes and fragility, because the user can choose to grab either with the flat stops 158 or can choose to grab an item more securely by allowing more surface of the textured grips 154, 157 to come in contact with the item when picking it up.

Further, in the embodiment shown in FIG. 4, the first textured grip 154, and the second textured grip 157 have the plurality of pliable ridges 156 that are rounded in shape, and having a rubberized coating, which facilitates gripping more securely without damaging items, unlike if the pliable ridges 156 were made from metal or wood or other undesirably rigid material.

With continued reference to FIG. 4, each the stationary gripping lever 142, and the mobile gripping lever 144 are shaped with the first arcuate inner surface 143, and the second arcuate inner surface 145, that each curve such that neither the stationary gripping lever 142, nor the mobile gripping lever 144 make contact with a floor or ground surface that the base 122 of the T-shaped walking cane 110 is disposed on, despite the stationary gripping lever 142 itself being positioned at the base 122 of the T-shaped walking cane 110.

Additionally, each the stationary gripping lever, 142, and the mobile gripping lever 144, incorporate the terminally disposed flat stop 158 for gripping items. The flat stops 158 also do not make contact with the floor as a result of the arcuate shaping of each lever. This configuration facilitates sanitary conditions, making it less likely the gripping mechanism 100 will dirty items the user means to pick up. In the embodiment of the present disclosure, as shown in FIG. 2, the stationary gripping lever 142 has the first hard stop 160 disposed between the first arcuate inner surface 143, and a hinge area 164. Also, the mobile gripping lever 144 has a second hard stop 162 disposed between the second arcuate inner surface 145, and the hinge area 164. The first hard stop 160 of the stationary gripping lever 142 is configured to abut the second hard stop 162 of the mobile gripping lever 144 when the trigger 138 is fully retracted to move the mobile gripping lever 144 into a closed-position. This configuration facilitates a more controlled grip by ensuring the user cannot over-extend the stationary and mobile gripping levers 142, 144. Likewise, the hard stops 158 are always properly aligned through the interaction of the first and second hard stops 160, 162 when gripping more delicate items.

Additionally, as shown in FIG. 2, the default position of the mobile gripping lever 144 relative to the stationary gripping lever 142, is an opened-condition. The opened-condition in conjunction with the arcuate shape of each the first arcuate inner surface 143 and the second arcuate inner surface 145, and together with the flat stop 158 of the stationary gripping lever 142, allows the user to use the gripping mechanism 100 even without engaging the trigger 138, by lifting or pushing items with the stationary gripping lever 142 alone.

In one embodiment, as seen in FIG. 4, the stationary gripping lever 142 of the T-shaped walking cane 110, has both an upper portion 164 and a lower portion 166. The upper portion 164 is disposed on the elongated cylindrical body 120, and the lower portion 166 is disposed on the base 122 and on the textured base-cap 124 of the T-shaped cane 110 so that the lower portion 166 is situated on the textured base-cap 124 as to not make contact with the ground surface the textured base-cap 124 rests on.

With continued reference to FIG. 4, the lower portion 166 of the stationary gripping lever 142 has a bottom surface 168. The bottom surface 168 extends outwardly from the textured base-cap 124 of the T-shaped cane 110, and the bottom surface 168 terminates in a flat end section 158. Additionally, the flat end section 158 has a gripping portion 170, and the gripping portion 170 of the flat end section 158 faces outwardly from the textured base-cap 124.

In an embodiment of the present disclosure, as shown in FIG. 4, the mobile gripping lever 144, is coupled to the elongated hollow cylindrical body 120 with an axle 147 and configured to be actuated by a cable 154 system. The mobile gripping lever 144 has an upper portion 172 and a lower portion 174, and the upper portion 172 of the mobile gripping lever is 144 bulbous and receiving the axle 147.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A T-shaped walking cane, comprising:
an elongated hollow cylindrical body;
a base;
a handle being positioned opposite of the base including, a first-section, a second-section, and a trigger hosted on a trigger-axle being positioned proximal to the second-section; and
a gripping mechanism actuated by the trigger including,
a stationary gripping lever affixed to the elongated hollow cylindrical body adjacent to the base of the T-shaped walking cane, the stationary gripping lever having a first arcuate inner surface with a first textured grip including a first rubber coating in which a plurality of first pliable ridges are formed, the stationary gripping lever terminating in a first flat end section disposed adjacent to the first arcuate inner surface, the first pliable ridges formed along an entirety of the first arcuate inner surface, and a first hard stop surface disposed between the first arcuate inner surface and the elongated hollow cylindrical body,
a mobile gripping lever having a hinge area hosted on an axle and disposed adjacent to the stationary gripping lever, and the mobile gripping lever being configured to move in relation to the stationary gripping lever via a manual operation of the trigger, the mobile gripping lever having a second arcuate inner surface with a second textured grip including a second rubber coating in which a plurality of pliable ridges are formed, the mobile gripping lever terminating in a second flat end section disposed adjacent to the second arcuate inner surface, the second pliable ridges formed along an entirety of the second arcuate inner surface, wherein each of the first arcuate inner surface and the second arcuate inner surface are concave, and the first arcuate inner surface faces the second arcuate inner surface, and a second hard stop surface disposed between the second arcuate inner surface and the hinge area of the mobile gripping lever, the second hard stop surface configured to abut the first hard stop surface when the trigger is fully retracted to move the mobile gripping lever into a closed-condition.

2. The T-shaped walking cane of claim 1, wherein the base comprises a textured base-cap.

3. The T-shaped walking cane of claim 1, wherein the first textured grip of the stationary gripping lever and the second textured grip of the mobile gripping lever are mating.

4. The T-shaped walking cane of claim 1, wherein the stationary gripping lever and the mobile gripping lever form a gripping claw configured to assist a user with picking up at least one item.

5. The T-shaped walking cane of claim 1, wherein the handle is horizontally-centered upon a vertical shaft of the elongated hollow cylindrical body forming the T-shaped walking cane.

6. The T-shaped walking cane of claim 1, wherein the stationary gripping lever ends in a flush position to the base of the T-shaped walking cane.

7. The T-shaped walking cane of claim 1, further comprising an illumination member positioned at the first-section, and a light-activation button, wherein the illumination member comprises an LED light.

8. The T-shaped walking cane of claim 7, wherein the T-shaped walking cane further includes a first-endcap and a second-endcap.

9. The T-shaped walking cane of claim 8, wherein the first-endcap is positioned at the first-section and is configured to host the LED light.

10. The T-shaped walking cane of claim 9, wherein the first-endcap is removable.

11. The T-shaped walking cane of claim 1, wherein depression of the trigger initiates retracting of the mobile gripping lever into a closed-condition.

12. The T-shaped walking cane of claim 11, wherein releasing of the trigger initiates extending of the mobile gripping lever into an opened-condition.

13. The T-shaped walking cane of claim 1, wherein the second-section of the handle comprises a trigger-indentation to accommodate the trigger when fully retracted.

14. The T-shaped walking cane of claim 1, wherein the elongated hollow cylindrical body houses a cable extending from the trigger to the mobile gripping lever being configured to initiate movement of the mobile gripping lever.

15. The T-shaped walking cane of claim 7, wherein the LED light is battery powered.

16. The T-shaped walking cane of claim 1, wherein the handle comprises an upward arch profile providing an ergonomic grip area.

17. The T-shaped walking cane of claim 16, wherein the first-section and the second-section of the handle each further comprise a padded portion.

18. The T-shaped walking cane of claim 1, wherein the stationary gripping lever has both an upper portion and a lower portion, and the upper portion is disposed on the elongated cylindrical body, and the lower portion is disposed on the base and on a textured base-cap of the T-shaped cane, and the lower portion is disposed on the textured base-cap and configured to not contact a ground surface when the textured base-cap rests on the ground surface.

19. The T-shaped walking cane of claim 18, wherein the lower portion of the stationary gripping lever has a bottom surface, the bottom surface extending outwardly from the textured base-cap, the bottom surface terminates in the flat end section, the flat end section having a gripping portion, and the gripping portion of the flat end section faces outwardly from the textured base-cap.

20. The T-shaped walking cane of claim 1, wherein the mobile gripping lever is coupled to the elongated hollow cylindrical body with an axle and configured to be actuated by a cable system, and the mobile gripping lever has an upper portion and a lower portion, the upper portion of the mobile gripping lever being bulbous and receiving the axle.
